(19) United States
(12) Patent Application Publication
(10) Pub. No.: US 2013/0132238 A1
(43) Pub. Date: May 23, 2013

(54) E-COMMERCE LOYALTY SYSTEM AND METHOD

(71) Applicants: Laura Ann Evans, Columbus, OH (US); Dale Thomas Edman, New Albany, OH (US); Richard Ruggerio, Columbus, OH (US); Elizabeth C. Demarchi, Columbus, OH (US)

(72) Inventors: Laura Ann Evans, Columbus, OH (US); Dale Thomas Edman, New Albany, OH (US); Richard Ruggerio, Columbus, OH (US); Elizabeth C. Demarchi, Columbus, OH (US)

(73) Assignee: RESOURCE VENTURES, LTD., Columbus, OH (US)

(21) Appl. No.: 13/678,050

(22) Filed: Nov. 15, 2012

Related U.S. Application Data
(60) Provisional application No. 61/561,047, filed on Nov. 17, 2011.

(51) Int. Cl. G06Q 30/06

(52) U.S. Cl. CPC G06Q 30/0639
USPC 705/26.61; 705/26.8; 705/26.9

(57) ABSTRACT

A multi-faceted, tier-driven, loyalty-based commerce selector that promotes brand and retailer loyalty is provided. The innovation leverages brand and retailer loyalty in lieu of price comparison shopping as is the focus of most other e-commerce experiences. Brands or retailers can be selected for exclusive shopping, and recommendations can be provided where brands or retailers are yet-unselected. Various interfaces and communications systems can be employed to deliver customized shopping experiences based on selected retailers and user preferences in order to shift from price to relationships as the driver of transactions.

### CROSS-REFERENCE TO RELATED APPLICATIONS

This application is related to U.S. Provisional Patent application Ser. No. 61/561,047 entitled “MULTI-RETAILER E-COMMERCE SYSTEM AND METHOD” and filed Nov. 17, 2011 and claims the benefit thereof. The entirety of the above-noted application is incorporated by reference herein.

### TECHNICAL FIELD

The subject innovation relates to the field of electronic commerce and, more specifically, pertains to methods and systems for arranging and conducting online sales transactions in a manner that is focused on and operates with respect to the relationship between at least two of buyers, distributors, and retailers.

### BACKGROUND

As product purchases and exchanges continue to emerge via the Internet, various structures have developed around such transactions. Generally, Internet transactions are referred to as electronic commerce or “e-commerce.” This can include the acts of buying and selling products and services via electronic systems.

With the continued popularity and ease of e-commerce transactions, the amount of trade conducted electronically has grown extraordinarily. This is facilitated by ubiquitous Internet access in today's society. In fact, a large and still-growing percentage of commerce is conducted entirely electronically (e.g., for items such as bill payment, money transfers, service purchases, et cetera). However, many e-commerce transactions involve transportation of physical items following an on-line purchase.

Further, the broad ecosystem of devices capable of conducting e-commerce over networks has in some ways complicated the completion of transactions. To support and sustain e-commerce, various regulations and standards have been promulgated. For example, security standards exist for the user of payment cards and other accounts online. Such aspects can be implemented in a variety of settings to improve security and integrity for retailers, shoppers, and other interested parties. Such regulations and standards must be integrated across a variety of disparate platforms engaging in e-commerce.

Even after such systems are developed, ongoing action must occur for both technical and business reasons. After secure e-commerce channels have been established and extended to external user experiences (e.g., shopping interfaces), a new situation can arise where an online merchandise distributor wishes to provide loyal customers the ability to purchase distributed product(s) via a preferred online retailer selected by the individual customer instead of forcing these customers to use an unpreferred online retailer without being given a choice. One way to enable this functionality is to provide a tiered product selector interface followed by displaying an online price as offered by multiple preferred retailers. This, in essence, becomes a comparison-shopping interface based predominantly on price instead and not distributor loyalty. There is a need in the art to provide an online product and/or service that is based upon distributor (or source, provider, and other entities acting in the chain of commerce) loyalty rather than those that promote price shopping and comparison.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, can comprise systems, architectures and methodologies that facilitate electronic commerce that leverages the communication power of a loyal online customer so as to benefit online distributors of all types of goods and services with dedicated repeat customers. This technique can be generally described as (but is not limited to) a multi-faceted, tier-driven, loyalty-based commerce selector.

In some aspects, one or more online retailers can enroll for participation in a loyalty-building program for affiliated e-commerce providers. Relevant technical features can include implementation of unified, standard-compliant proxy services for retailer e-commerce means. One or more databases can be employed to track retailers and their respective products, and/or particular brand offerings. The databases can associate various configurations and quantities with a variety of other information to facilitate compatibility with the loyalty-building program and the interfaces used by consumers and program administrators. Databases can be realized as a data feed that couples with a particular seller experience. The data feed can include product identifiers (e.g., SKUs) and product options (e.g., colors, types, sizes) for products carried by one or more preferred online retailers. Products can be selected upon feed population to reflect the goods and/or services that are available for purchase online.

In additional aspects, one or more user interfaces can be developed for use in conjunction with a loyalty-building program. At least one interface can be designed for consumer use, and can facilitate a consumer commitment to shop with specific retailers or for specific brands. In some embodiments, the consumer interface can be a distributor's specific online experience. In other embodiments, a generic interface can be employed that integrates with a distributor's online experience upon selection or preference setting by the consumer. Other interfaces can be employed by administrators or brand and/or retailer representatives to enable transformation of store data to data that conforms to the databases queried by the consumer interfaces as well as to manage the loyalty-building programs.

In further aspects, an online customer using a consumer interface can identify a product he or she wishes to purchase, and can thereafter submit a “purchase request” or add the product to a shopping cart not yet associated with a retailer. A retailer can be selected from a series of retailers capable of fulfilling this purchase request. Once the customer selects a retailer, and/or commits to purchase from a particular retailer, future searches can be confined to the identified retailer and exclude other competitors. Similar mechanisms can be employed with respect to brands or other entities in commerce with which a customer can develop an ongoing relationship or preference.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of an e-commerce management system in accordance with aspects of the innovation.

FIG. 2 illustrates an example block diagram picturing an implementation of a system for a tiered e-commerce system based on source loyalty.

FIG. 3 illustrates an embodiment of a system for enabling source-based electronic commerce.

FIG. 4 illustrates an embodiment of a system for maintaining a database used in e-commerce based around retailer loyalty.

FIG. 5 illustrates an embodiment of a system for effecting a consumer application used in e-commerce based around retailer loyalty.

FIG. 6 illustrates an example methodology of a multi-retailer e-commerce experience in accordance with aspects of the innovation.

FIG. 7 illustrates a sample methodology for loyalty-based e-commerce including locating a retailer for selection.

FIG. 8 illustrates a sample methodology for loyalty-based e-commerce employing a retailer experience interface.

FIG. 9 illustrates an example and conceptual illustration of a customer-centric, loyalty tiered arrangement of product options deriving from an aggregated data feed of several online retailer e-commerce experiences.

FIG. 10 illustrates a brief general description of a suitable computing environment wherein the various aspects of the subject innovation can be implemented.

FIG. 11 illustrates a schematic diagram of a client-server-computing environment wherein the various aspects of the subject innovation can be implemented.

### DETAILED DESCRIPTION

As set forth supra, the innovation disclosed and claimed herein, in aspects thereof, can facilitate electronic commerce driven by buyer loyalty instead of price.

In some aspects, implementations can identify a group of online retailers. One or more retailers or groups can be enrolled for participation as affiliated e-commerce providers. Information specialists or technologists can implement a unified, standard-compliant proxy service for each of the enrolled online retailer websites. In some embodiments, a distributor or technology representative can develop a single, specific online experience to aggregate these different online retailers' e-commerce functions into one unified product selector-based experience.

Data regarding each of the online retailers and respective product offerings can be maintained in a data feed coupled to the distributor's online experience. Such data can include, but is not limited to, product identifiers (e.g., SKUs) and product options (e.g., colors, types, sizes). In some embodiments, the identifiers and options are common to each of the preferred online retailers.

An online customer using the distributor's specific online experience can identify a product desired for purchase and locate a preferred retailer to purchase the product before finalizing a transaction. Upon indicating an intention to purchase, a common product identifier is described by the aggregated data feed. The specific experience can return purchase information to a tier-driven user interface for product selection that includes an aggregated retailer result for the particular sought product. The online customer can proceed through a series of choices, beginning with each available product option, followed by each remaining retailer to carry those preferred options, followed by the preferred quantity. The final result of this process is a presentation of the price and an option to “Add to Cart.” After the customer has shown purchase intent with their preferred retailer, all subsequent products shown beyond establishing retailer preference will proceed with the preferred retailer and discontinue showing multi-retailer information to this customer.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term “module” is intended to denote a useful aspect or aspects accomplished at least in part using computerized means. Some aspects described as modules can be a plurality of modules; some aspects described as modules can be sub-modules existing within larger modules. Modules can exist in different logical arrangement, and include functionality not expressly detailed, while still conforming to the spirit of the innovation.

In the context of the innovation, the term “brand” generally refers to a product's origin. For example, a store can carry a variety of brands for a variety of products. A brand can include a variety of models, variants and options in their brand line. As used herein, the term “retailer” or “vendor” is a business that sells products. A retailer can be a brand in and of itself, but as used herein, “brand” is generally intended to denote the product's original or primary attribution, rather than a business-to-consumer seller, except where such definition conflicts with usage. A distributor can be a retailer, or a business-to-business entity (e.g., business-to-business branch of a manufacturing brand or middle participant that brokers between manufacturer and separate point-of-sale businesses).

A “source,” “purchase source,” or similar terms can include brands, retailers, distributors, or other channels for purchasing one or more products anywhere in the chain of commerce, from production to end user. The concept of a source permits entities at all points in a product delivery cycle to act on cares regarding the sources from which they receive products, including what brands are involved and the status of relationships between different market entities. Thus, a source can be the manufacturer, various distributors, various sales entities, or the seller who provides the product's final disposition to a consumer. In some embodiments, aspects herein can be leveraged in secondary markets, and resellers or consumer-sellers can be a source.

A consideration set, as used herein, is the group of brands a given consumer identifies and investigates prior to a purchase decision (e.g., plurality of sources). While a consideration set as commonly used may refer to the set of brands relating to or competing with respect to one purchasing decision, as used herein this term or phrase can also indicate all of the brands a consumer identifies with—the sum total of brands a consumer looks to, or desires to, fulfill the sum total of their purchases. For example, in this context, a high-end consumer concerned with shopping experience and after-sale support can have a different consideration set than a budget-minded consumer looking to meet a requirement for the minimum cost. Thus, the concept of “consideration set” is not just what brands each respective consumer would look to for one single purchase. Put another way, these consideration sets can be applied across all purchasing decisions made by each respective consumer, and are not limited to any one purchase. For example, the consideration set of the high-end consumer can include luxury import automobiles, comfortable automobile service centers, new-release electronics purchased at specialty stores, custom-tailored clothing, gourmet food, and so forth. The budget-minded consumer can be interested in multifunction domestic automobiles, fast and inexpensive automobile service centers or auto parts stores, sale-priced electronics from big-box stores, long-lasting clothing on sale, food with a long shelf life, and others.

Values (e.g., qualitative values infra), politics and preferences can also play into these consideration sets, as the identity of a business, its leadership, or its purchasing demographic can add or remove that particular business from a consideration set that might otherwise apply.

As suggested, a consumer's desire to remain loyal to a brand or other source can stem from a variety of influences. For example, preexisting business relationships or the desire to support businesses that are parts of distant relationships can influence a buyer's desire to work with a particular source. Qualitative values such as business ethics, community involvement, materials sourcing, employee care, and others can also influence a buyer's decision to commit to a particular source. As used herein, “qualitative values” and analogous terms will refer to transaction participant that can be identified and/or associated in related groups, even if such values are not quantitatively measurable, or only quantitatively measurable as a binary (e.g., “yes” or “no”). Specific, narrow examples of qualitative values can include appreciation of policies associated with a source, such as (but not limited to) dolphin safe fishing, charitable donations, sustainable forestry, alternative energy use, and others. Such examples are provided to merely suggest the spirit of such qualitative values rather than set forth any comprehensive description or limit the spirit of the concept.

A buyer at any point in the chain can “commit” to a source, or otherwise establish customer loyalty, in accordance with some aspects herein. Systems and methods described infra can automate commitment and make it convenient for the buyer. Commitment can include, for example, selecting a preferred source and shopping exclusively from that source when desired products are available from that source. The automated steps can include “locking down” aspects of a buyer interface to deal exclusively with the source to which the buyer has committed. Such “locking down” can include, at least in part, searching only for products or variants available from the source to which the buyer is committed. Other aspects related to buyer commitment can include unlocking or making available aspects available from the source that are offered only to committed buyers, and enabling others perquisites reserved for loyal customers. Other aspects related to source commitment will be apparent in view of the disclosure herein.

Various aspects herein can be practiced on mobile devices. A mobile device can generally refer to a communication system designed for wireless use. Examples of mobile devices can include, but are not limited to, cellular telephones, personal digital assistants, tablet devices, notebook or laptop computers, and others.

Electronic commerce is subject to regulation and requires substantial security compared to local processing or less sensitive data transfer over networks. The Payment Card Industry Data Security Standard (PCI DSS), hereinafter referred to as the Standard, is a worldwide information security standard defined by the Payment Card Industry Security Standards Council. The Standard can provide security controls related to e-commerce data in an attempt to prevent credit card fraud and other malicious attacks. The Standard applies to all organizations that hold, process, or exchange cardholder information from any major credit card and/or other accounts. Aspects herein can employ the Standard in order to provide security where necessary and/or desirable. For example, the Standard or other heightened security can be employed during a checkout procedure, but need not be employed while browsing prior to requesting or accessing payment information. In various embodiments, additional or alternative security means can be employed without departing from the spirit of the innovation.

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

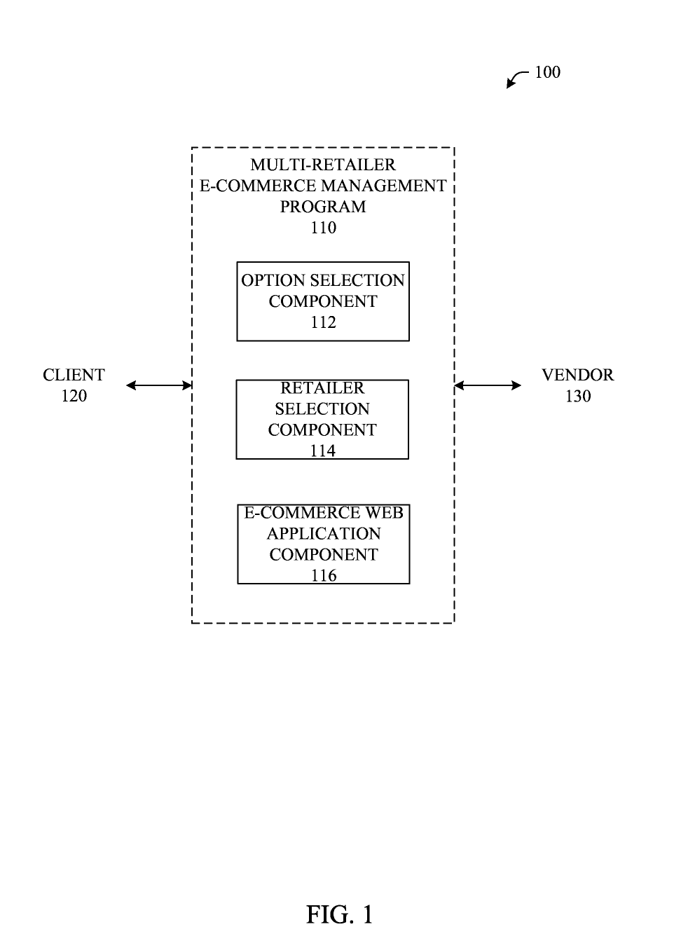

Referring now to FIG. 1 illustrates an example block diagram of system 100 including multi-retailer e-commerce management program 110. Generally, program 110 can include an option selection component 112, a retailer selection component 114, and an e-commerce web application component 116. Each of these components will be described infra.

In operation, the innovation utilizes a network or group of e-commerce providers. Here, the providers include a group of preferred online retailers. For example, such a retailer can be a chain department store or others. As will be noted, in accordance with the innovation, a desire or loyalty to purchase from a select retailer can be leveraged as a product of brand purchases.

An implementation of the innovation can begin with a technologist who can enable service to each of the preferred online retailer websites, in compliance with the Standard and other requirements. In some embodiments, the distributor can build (optionally, in partnership with the technologist) a single, specific online experience to aggregate these different online retailers' e-commerce functions into one unified product selector-based experience. An embodiment for such a system 100 shown in FIG. 1.

In the example, to facilitate generation of useful information, data regarding each of the online retailers is maintained in a data feed coupled to the distributor's specific online experience, such data including product identifiers (e.g., SKUs) and product options (e.g., Colors, Types, Sizes, others) common to each of the preferred online retailers, selected by the retailer upon feed population to reflect the goods and/or services, at the retailers discretion, which are available for purchase online.

An online customer using the distributor's specific online experience can identify a product he or she wishes to purchase, and submit a “purchase request” which automatically selects the common product identifier described in the aggregated data feed. Thereafter, the specific experience can return a tier-driven user interface for product selection that includes an aggregated retailer-configured result for that particular purchasable product.

The online customer can then step through a series of choices, beginning with a selection for each available product option, followed by selecting one or more of the remaining retailers carrying the desired combination of options. After determining the product, options and retailer to purchase from, a purchase quantity can be provided. In some embodiments, quantity can be evaluated prior to selecting a retailer to ensure sufficient inventory to complete an order. The final result of this process is a presentation of the price and an option to “Add to Cart.” Because this customer has shown purchase intent with their preferred retailer, all subsequent products shown beyond this point will assume this preferred retailer and discontinue showing multi-retailer information to this customer.

In accordance with aspects relating to selection of product options above, multi-retailer e-commerce management program 110 can include option selector component 112 which enables a consumer to narrow a product choice according to product options (e.g., size, color, pattern). A user can reach option selector component 112 through a dedicated portal (e.g., executable program, remote application, custom browsing app), a generic network access application (e.g., web browser), or other means. In some embodiments, a user can select a product or class of products prior to utilizing option selection component 112. In other embodiments, a product may be selected concurrently or after choosing product options. Option selection component 112 can accept user input in a variety of ways, including (but not limited to) pull-down menus, checkbox menus, descriptive buttons, radio buttons, drag-and-drop/what-you-see-is-what-you-get bins, text searching, text input with recognition, and others.

Once a product and its options are narrowed, retailer selection component 114 can populate to include retailers for which the selected product, with the selected options, is available. The e-commerce web application component 116 can enable a user to select quantity and complete one or more purchases with a selected retailer. Thereafter, all product lookups (e.g., searching or browsing to a product) can default to the selected retailer. This can benefit both the consumer and retailer. The consumer can confidently and rapidly search and purchase products online without being confined to a single experience or website (e.g., single business, less-flexible aggregator) while knowing their businesses is directed to support the business or only offer the brands of their choice. The retailer benefits by way of gaining a loyalty-based sales channel that assists in valuing and leveraging brand and retailer recognition.

Thus, client 120 can “commit” to a single retailer, vendor 130, at least with respect to a portion of products and/or services offered by vendor 130, using multi-retailer e-commerce management program 110. Other aspects included in multi-retailer e-commerce management program 110 can include various storage, transmission and reception, and processing hardware, as well as administrative tools to permit vendor 130 to update their e-commerce presence and develop the shopping experience for client 120. Client 120, as well as vendor 130, can access program 110 or portions thereof at least in part using electronic devices such as computers, mobile devices, and other devices capable of network access (e.g., “smart” televisions, network-enabled peripheral devices such as disc players and/or external media players).

At least in part by use of retailer selection component 114, client 120 can quickly adapt retailer preferences. For example, in embodiments where program 110 aggregates a large number of retailers and/or products (e.g., vendor 130 is a large set, vendor 130 includes many products of different brands) retailer or brand names can be presented to client 120 while client 120 is shopping. Interfaces within e-commerce web application component 116 or other components can be provided to allow a user to rate, or prefer or avoid particular retailers or brands. For example, an interface can include a menu or variety of buttons allowing a user to express a positive sentiment toward a brand or retailer; express a negative sentiment toward a brand or retailer; express a neutral/undecided sentiment toward a brand or retailer; or indicate they lack sufficient information to personally judge the brand or retailer. Accordingly, brands or retailers associated with negative feedback can be avoided in client 120's shopping in the future, instead predominantly facilitating shopping from brands or retailers with positive feedback, and querying client 120 or defaulting to neutral or unknown brands or retailers when desired products are not available from preferred sources.

In some embodiments, brands or retailers (e.g., among a set represented by vendor 130) that receive feedback suggesting insufficient information or negative impressions are reaching client 120 can attempt to educate consumers on their business. In one or more embodiments, brands associated with feedback suggesting a lack of information or negative opinions can offer incentives to users to encourage an initial purchase and an opportunity to earn the user's approval. In alternative or complementary embodiments, strategic relationships between brands or retailers (e.g., non-competing but existing in a common consideration set) can be employed to allow an unknown business (e.g., among vendor 130) to reach out to consumers (e.g., among client 120) of a known business (e.g., preferred business also among vendor 130).

E-commerce management program 110 can provide each user with a multifaceted shopping experience. The experience can include features customized by vendor 130, including sensory interaction such as visual appearance, movement, interactive and dynamic content, sound, and so forth. Aspects can be functional, aesthetic, or combinations thereof. Entertainment aspects not directly related to the function can be incorporated (e.g., music player, games, chat). Thus, an “experience” can be developed by vendor 130 to further cultivate repeat customer loyalty in client 120.

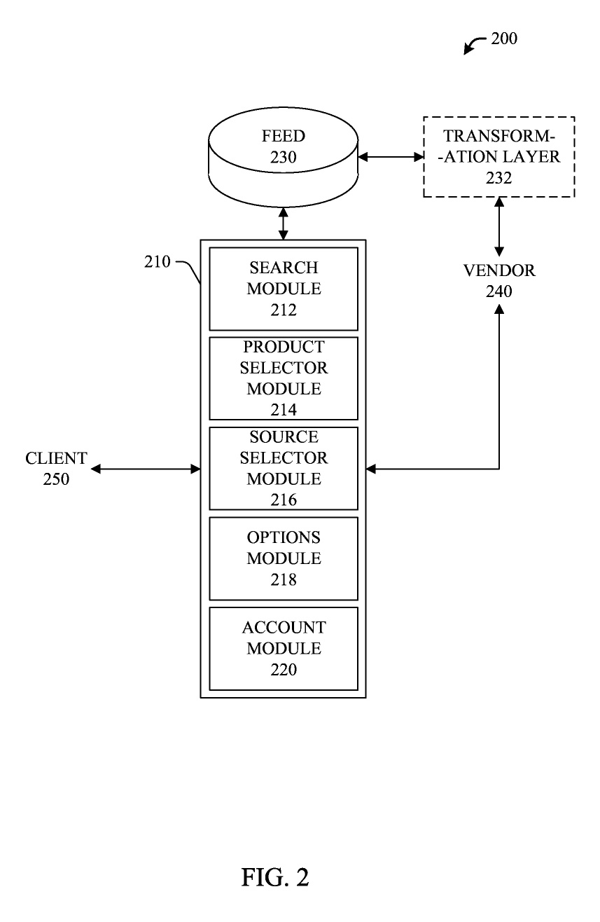

A variety of embodiments for similar techniques will be appreciated by those skilled in the art in view of the disclosures herein. Turning now to FIG. 2, illustrated is an example block diagram picturing an implementation of a system 200 for a tiered e-commerce system based on source loyalty. Client 250 can seek a product using system 200, including not only finding and purchasing the product, but finding the product through a particular source. A source can be, but is not limited to, a particular retailer, brand, distributor, location, vendor, and others (or as described elsewhere herein, inclusively). System 200 can include e-commerce program 210, which can further include (but is not limited to, and need not include all of) search module 212, product selector module 214, source selector module 216, options module 218, and account module 220. E-commerce program 210 can receive information from feed 230, and vendor 240 can access feed 230 and e-commerce program 210 to provide information that will be used by client 250 in browsing and purchasing.

Vendor 240 can facilitate a loyalty-based e-commerce architecture by updating feed 230. Feed 230 can include data that is provided to electronic commercial channels, such as e-commerce program 210, which allows consumers, such as client 250, to shop online. Feed 230 can include data that is formatted for use with e-commerce program 210, or can include a transformation layer 232 that imports and standardizes data from other sites. In some embodiments, feed 230 or portions thereof can be customized to a particular source or group of sources. For example, feed 230 can use a proprietary arrangement of information for use with e-commerce program 210. In other embodiments, e-commerce program 210 requires a particular arrangement of data for compatibility, and the transformation layer 232 of feed 230 can be specifically designed to pull and/or convert information from vendor 240's information that was prepared in advance (or for other purposes). In still other embodiments, feed 230 can include a generic transformation layer 232 that uses one or more of text recognition, image recognition, searching, metadata, and/or other technologies to import information available from vendor 240 and other vendors. In other embodiments, feed 230 includes no transformation layer at all, and simply accepts information that is properly formatted for use with feed 230 and/or e-commerce program 210.

In various embodiments, feed 230 can self-update or be updated by vendor 240 subsequent to purchases, shipments (inbound or outbound), completed manufacturing, and other activities that impact product stocking information and inventories. Feed 230 can additionally employ various techniques known in the art to maintain virtual catalogs and inventories, including interfacing with third-party inventory management software and/or stored inventory files and/or databases. In some embodiments, feed 230 can maintain inventory both related to online sales and in-store purchases where vendor 240 has both electronic and physical storefronts and comingles inventory for both.

In some embodiments, vendor 240 can be a plurality of vendors. In such embodiments, vendors included in vendor 240 can coordinate for design and management of feed 230 and e-commerce program 210. Alternatively, a single vendor or third party administrator can manage feed 230 and e-commerce program 210. Such management can include or exclude ensuring information from the plurality of vendors included in vendor 240 is integrated into feed 230 for use by e-commerce program 210.

Vendor 240 can also interact with e-commerce program 210. In some embodiments, e-commerce program 210 is a custom installable program, app, website, interface, or other means effected at least in part using electronic devices, permitting client 250 to search, browse, locate, request, order, pay, and perform other activities related to commerce involving at least vendor 240. In addition to controlling the presentation of e-commerce program 210, some embodiments permit vendor 240 to customize the function, appearance, and other aspects of e-commerce program 210.

Search module 212 of e-commerce program 210 can facilitate searching, browsing, or other means of locating one or more products included in feed 230. Search module 230 can include text searching, product trees or hierarchies, and various menus or other options to facilitate both simple and comprehensive interfaces for product location. Client 250 or other entities can locate one or more products using search module 212, whereafter one or both of search module 212 and product selector module 214 can present results related to the search located at least in feed 230.

Product selector module 214 can permit client 250 or other users to select a particular product from among one or more listings rendered at least in part using search module 212. Product selector module can provide this information to source selector module 216.

Source selector module 216 allows a user to select a source from which to purchase selections made using product selector module 214. For example, a user may wish to buy only from a particular retailer. In another example, a user may wish only to only purchase products manufactured by certain makers. Source selector module 216 can be used to select the source from which a product will be purchased. In some embodiments, after a source is selected using source selector module 216, source selector module 216 can be hidden, locked, disabled, or otherwise removed from a product purchase cycle on subsequent uses of e-commerce program 210, thus allowing client 250 to commit to their desired source of products. In various embodiments, use of the modules of e-commerce program 210 need not be sequential, and source selector module 216 can be used before or after other modules, allowing client 250 and others to select a desired source to shop from at any stage of a shopping experience.

E-commerce program 210 can further include options module 218. Options module 218 can permit a user to select the particulars of a product located using search module 212 and product selector module 214 including product options (e.g., sizes, colors, add-ons and accessories, et cetera) and quantity. In some embodiments, options module 218 can include a subsequent or refining search. In other embodiments, a series of menus or selections can be presented showing what variants of a selected product are available from a selected source. In embodiments, options module 218 can be a sub-module, or included in, at least one of search module 212 and product selector module 214.

Finally, e-commerce program 210 can include account module 220. Where client 250 uses e-commerce program 210 in an ongoing basis, an account can be created and managed through account module 220. Account module 220 can read and write to an external database to store account information securely. In some embodiments, the external database can be feed 230. In other embodiments, the external database can be a storage component not pictured. Client 250 and/or vendor 240 can manage consumer and administrator accounts (as well as other accounts of varying permission levels as will be appreciated by those skilled in the art) using account module 220. Aspects managed can include, but are not limited to, sources selected via source selector module 216 (e.g., unlocking after a previous selection), contact and shipping information, payment information, purchase history, scheduled purchases, shopping lists, feedback and communications, loyalty information, and others aspects pertinent to e-commerce accounts.

In some aspects, account module 220 can save and/or forward the histories of one or more purchasers for aggregation in a purchaser history database. The purchaser history database can be used to categorize groups of purchasers according to their values (e.g., qualitative values), considerations sets, and other preferences.

In some embodiments, an interface can be employed to schedule purchases for items that are bought repeatedly. For example, high-end consumers may purchase new clothing seasonally. Recommendations based on the values and tastes can be made via their preferred retailer, and the shopping process can be expedited based on approval of the recommendations rather than a lengthy browsing session. In another example, a large family can re-purchase toiletries every week, and can save time by having the purchase preapproved to ship on a specified day of the week, or using a rapid approval of a pre-planned purchase. In some embodiments, a user can receive an email with a purchase approval link for scheduled purchases. In another embodiment, a user can receive an email or text directing the user to open the user interface to respond to notifications relating to scheduled purchases or other purchase items.

Loyalty information can include perks, reminders, rewards, incentives, coupons, and other aspects (including those that are available to be used, those that are pending in a current transaction, and/or those that were used in a previous transaction). Thus, in addition to the shopping preferences of client 250, additional features encouraging client 250 to remain “committed” to a source are enabled by e-commerce program 210. Further, vendor 240 can observe the usage and impact of incentives on particular clients, singly or in the aggregate, to tailor their loyalty programs in view of the feedback. In some embodiments, an administrator-related aspect of account module 220 can provide recommendations to vendor 240 in view of history or statistically-developed impact information related to a loyalty program.

Those skilled in the art will appreciate the modules detailed in FIG. 2 can be combined, hybridized, and/or act in varying degrees of dependence or independence. An e-commerce program capable of effecting the function of e-commerce program 210, and conforming to the spirit of the subject innovation, need not specifically define modules as described herein, and the example illustrated in FIG. 2 is intended only to facilitate a general understanding of the concept rather than provide an exhaustive list of all possible arrangements, combinations and/or means of providing interfaces and shopping experiences of this nature to various clients including client 250, as well as various sources including vendor 240.

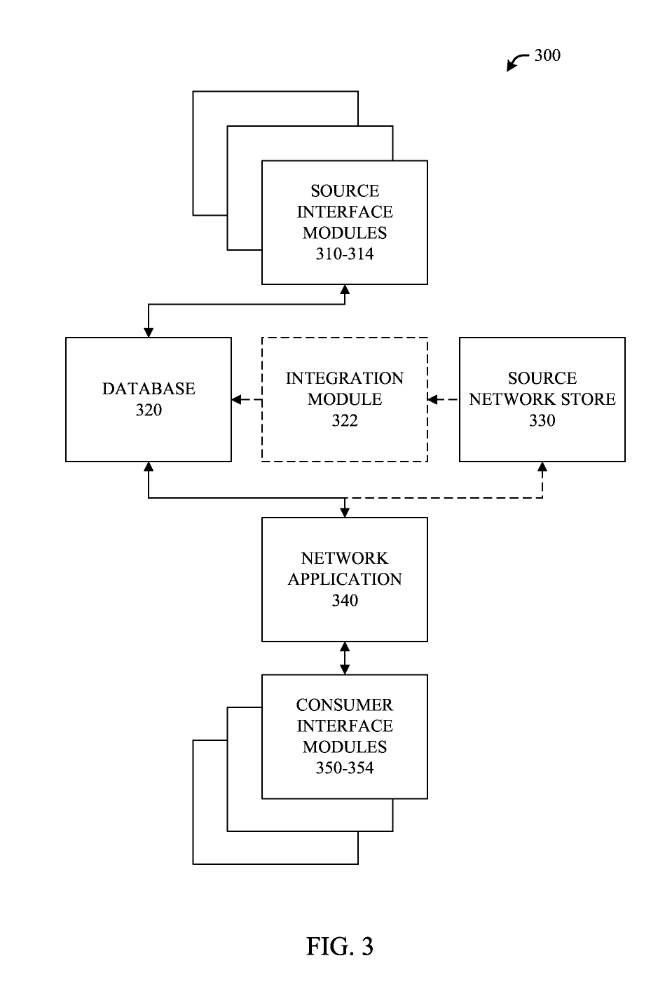

Turning now to FIG. 3, illustrated is an embodiment of a system 300 for providing source-based electronic commerce. System 300 can include a plurality of source interface modules 310-314, database 320, source network store 330, network application 340, and consumer interface modules 350-354. System 300 can also include integration module 322 in some embodiments.

Source interface modules 310-314 provide one or more product sources (e.g., retailer, manufacturer, brand, business, conglomerate, associated group of businesses, and others) an interface by which to manage a source-based electronic shopping experience. Source interface modules 310-314 can include administrator tools used for designing, modifying, and managing network application 340. Source interface modules 310-314 can also include administrator tools for creating and/or modifying database 320.

In some embodiments, the plurality of source interface modules among source interface modules 310-314 are a plurality of interfaces within a single organization. For example, distant entities involved in the same business concern can utilize more than one interface to maintain the concern from multiple locations. In some embodiments, source interface modules 310, 312 and 314 can include different permissions for different users. In other embodiments, source interface modules 310-314 can be the same.

In alternative embodiments, source interface modules 310-314 can each be associated with different business concerns. For example, a group of businesses can implement network application 340, which facilitates source-based shopping by consumers, together. Each business concern can access at least one of source interface modules 310-314 to maintain database 320 and modify network application 340 in accordance with the agreement between the business concerns and their respective permissions. In some embodiments, one or more of the business concerns accesses a functionally different source interface module among 310-314 than is available to the other business concerns. In alternative embodiments, all business concerns employ a functionally similar or identical source interface module among 310-314. In embodiments, particular users within the business concern (e.g., executive, inventory manager, information service technician, others) can access a functionally different source interface module among 310-314 than other users (e.g., service representative, salesperson).

Source interface modules 310-314 can communicate with at least database 320. Database 320 can include, but is not limited to, inventory information related to products available from at least one source associated with source interface modules 310-314. Database 320, in some embodiments, can also receive information from source network store 330. Source network store 330 can be an online or electronic store or shopping capability associated with at least one source associated with source interface modules 310-314 (e.g., web store for a particular business). Source network store 330 can be provided via a dedicated web site, application, program, or other means at least partially accomplished using electronic devices. In some embodiments, integration module 322 can import information from source network store 330 to database 320. This can, but need not, include converting information located at source network store 330 to a format compatible with database 320 for use by network application 340.

In some embodiments, database 320 can include additional information in support of sales conducted electronically. For example, consumer information, payment systems, marketing materials, sales histories, loyalty program management, and other aspects supporting system 300 and other aspects described herein can be stored in database 320.

Network application 340 can include a loyalty-based shopping experience, managed via source interface modules 310-314, and used by consumer interface modules 350-354, to allow consumers to purchase products from their desired sources. Network application 340 receives information at least from database 320 and consumer interface modules 350-354 to facilitate electronic sales between sources and consumers. Optionally, network application 340 can include information from or link to source network store 330. Network application 340 can include, but is not limited to, various interfaces, programming, sensory aspects (e.g., appearance and associated sounds), and functionality required to permit customers to operate and purchase through a store accessible at least in part via electronic devices.

Consumer interface modules 350-354 are the modules that accept user input and display at least aspects of network application 340 to facilitate sales between consumers and sources. In some embodiments, consumer interface modules 350-354 can be a custom or proprietary program, installer, executable, interface, or other component that is run and/or stored at least in part on a consumer's local device. In other embodiments, consumer interface modules 350-354 can be a preexisting network utility (e.g., computer web browser, mobile shopping app) that loads network application 340 where network application 340 is formatted according to one or more standards in use by the respective utility.

Consumer interface modules 350-354 can be customized to show users' preferred brands and retailers to give them rapid access to desired or frequently purchased products or sources. In some embodiments, quick links, icons, shortcuts, or other interface features can be automatically or manually integrated into one or more portions of the interface. In some embodiments, incentives or coupons can be identified and prominently displayed in the interface. Coupon or incentive-based items can be aggregated and totaled for one or more brands or retailers, and cross-marketing can be employed whereby various brands or retailers can offer “bundled” deals to encourage simultaneous loyalty to both businesses.

In some embodiments, network application 340 and consumer interface modules 350-354 can be combined or are accomplished in a single component. For example, in the case of a mobile shopping app used on a smartphone or tablet device, an interface and web store can be compartmentalized in a single app package. Alternatively, aspects can be separated according to different functions (e.g., some functions executed on remote server, others on a local consumer device, in manners alternative to the depiction in FIG. 3). Likewise, network application 340 can be stored and/or executed, entirely or in part, in or on database 320 or associated hardware.

While aspects such as source interface modules 310-314 and consumer interface modules 350-354 are shown in particular quantities, such numbers are illustrated as such only to provide a manageable example, and should not be construed as displaying a preferred arrangement or limiting embodiment. Fewer or greater numbers can be employed in accordance with the subject innovation and disclosures herein without departing from the spirit and concept of systems and methods described.

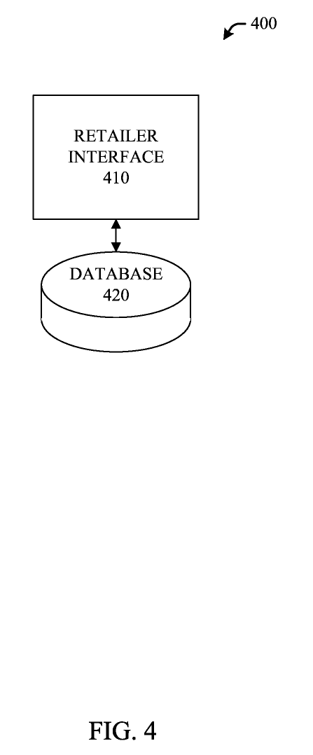

Turning now to FIG. 4, illustrated is an embodiment of a system 400 for facilitating a database used in e-commerce based around retailer loyalty. System 400 can include retailer interface 410 and database 420.

Database 420 can include, but is not limited to, product information for products associated with a retailer. In some embodiments, a plurality of retailers can include products in database 420. In such embodiments, the products can at least be sorted, searched or organized by retailer. In various embodiments, database 420 can include other information, such as inventories, locations, sales histories, consumer information, payment information, and various applications or architectures to facilitate aspects of electronic commerce.

In various embodiments, database 420 can be a database expressly for system 400; a database shared with system 400 and alternative electronic commerce mechanisms; a database shared with system 400 and physical commerce entities (e.g., brick-and-mortar retail stores); a database shared with system 400 and other distribution and/or logistics channels; or other combinations and variants of such techniques. Thus, database 420 can represent a dedicated inventory exclusively for system 400, or a shared inventory used in other sales and distribution channels.

Retailer interface 410 can include, but is not limited to, various controls, interfaces and tools for maintaining database 420. For example, retailers can add and remove products, associated information, product options, inventory numbers, and so forth. Retailer interface 410 can also allow one or more retailers to offer, redeem and manage loyalty programs, and/or contact consumers (e.g., previous, current, or prospective product buyers). Retailer interface 410 can further, or alternatively, include other aspects described herein in relation to various interfaces.

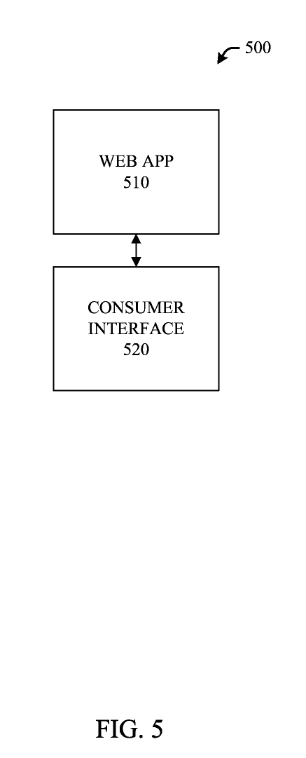

Turning now to FIG. 5, illustrated is an embodiment of a system 500 for effecting a consumer application used in e-commerce based around retailer loyalty. System 500 can include web app 510 and consumer interface 520.

Web app 510 can access information including, but not limited to, product information for products associated with one or more retailers. In some embodiments, web app 510 can search products associated with a plurality of retailers. In such embodiments, the products can at least be sorted, searched or organized by retailer. In various embodiments, web app 510 can access other information, such as inventories, locations, sales histories, consumer information, payment information, and various applications or architectures to facilitate aspects of electronic commerce.

In some embodiments, web app 510 includes (or is associated with hardware including) storage including product databases and components for completing e-commerce transactions.

Consumer interface 520 can include, but is not limited to, various interfaces, ports, communication means, and functions for interacting with or locally delivering (e.g., to a user device) web app 510. For example, consumers can use consumer interface 520 to select a retailer and/or brand, search for products, select products, choose product options and quantities, and complete a transaction related to such products or others. Consumer interface 520 can also allow one or more consumers to locate, redeem and manage loyalty programs. In some embodiments, consumer interface 520 can further permit consumers to contact. Consumer interface 520 can further, or alternatively, include other aspects described herein in relation to various interfaces.

In various embodiments, web app 510 and/or consumer interface 520 can be a single component; or alternatively be described or realized in more components than illustrated. Web app 510 and/or consumer interface 520 can be components developed expressly for system 500 (e.g., proprietary system) or can leverage utilities such as browsers or mobile applications by providing data thereto.

In some embodiments, consumer interface 520 can be executed and/or stored, at least in part, in or on web app 510 or associated hardware.

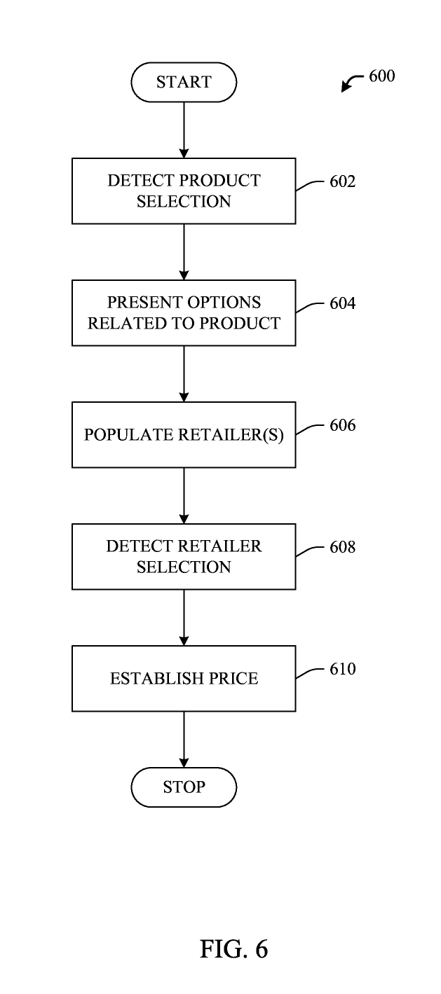

FIG. 6 illustrates a methodology 600 for loyalty-based e-commerce in accordance with an aspect of the innovation. While, for purposes of simplicity of explanation, the methodology shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 602, the system detects selection of a product by a consumer. For example, a consumer can select a type and brand of diapers. Thereafter, at 604, a variety of options are gathered and presented to the consumer for selection and to further narrow their desired purchase. For instance, with the diaper example, the user can be presented with options such as, “training pants,” “gender,” “size,” and others. It will be appreciated that in aspects, selection of options may trigger population of different options based upon a previous selection.

Based upon a consumer's selection of options, at 606 a retailer dropdown can be populated. Here, the dropdown is populated with retailers who either carry or stock a particular product/option combination. From the list, at 608, the system detects a preferred retailer from the list. It will be understood that selection of a retailer promotes loyalty for both a brand as well as to a retailer. In some embodiments, the detection at 608 can precede population of the retailer dropdown at 606 in order to preempt display of non-preferred retailers. Thereafter, at 610, the price is established for the product.

It will be understood that the above methodology promotes loyalty and not price shopping. Rather, once a participating retailer is selected and the product is put into an e-shopping “cart,” for that consumer, the retailer option is no longer available. In other words, for subsequent product lookups, the consumer is locked into that retailer.

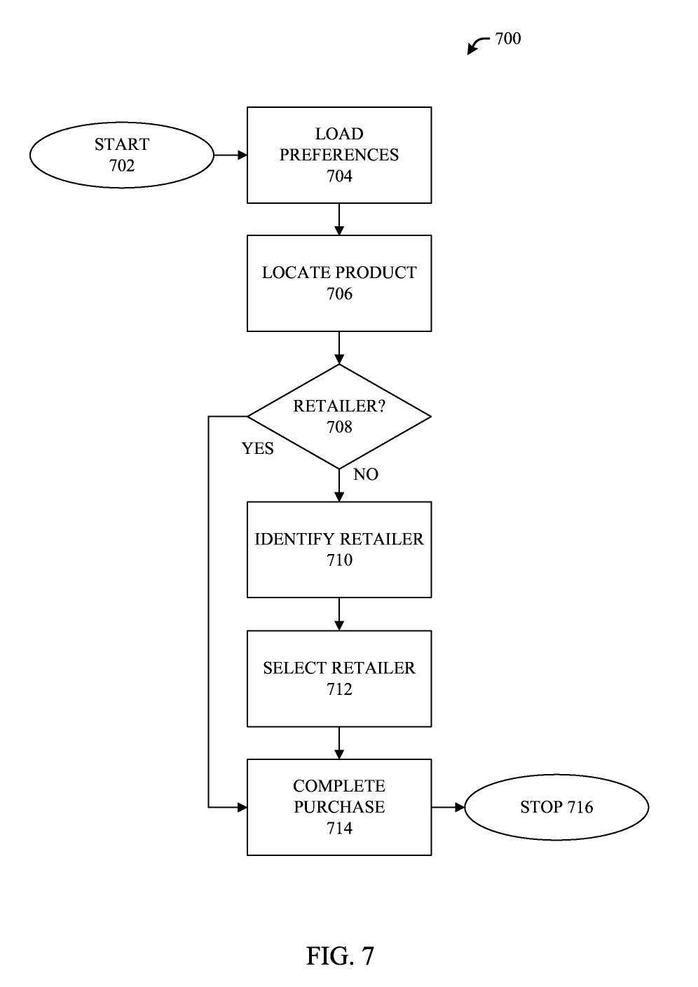

Turning now to FIG. 7, illustrated is a sample methodology 700 for loyalty-based e-commerce in accordance with one or more aspects of the disclosure herein. Methodology 700 starts at 702 and proceeds to load preferences at 704. Preferences can be, but are not limited to, a preferred purchasing source. The purchasing source can be a particular distributor, retailer or brand, and in embodiments allows the user to search and/or purchase only from the desired purchasing source. If no previous transactions have been conducted (e.g., from other iterations of methodology 700 or as facilitated by other portions of the disclosure), a purchasing source preference can be established at 704 or elsewhere in methodology 700. Other preferences such as shipping and payment options, shopping lists, and/or other stored information relating to the consumer.

At 706, a product can be located. Searching, browsing, selecting menu options, and other techniques can be employed to locate the product. After the product is located, a check is performed to determine whether a selected retailer carries the selected product at 708.

If the check at 708 determines the retailer does not carry the located or selected product, a retailer that carries the product can be identified at 710. In some embodiments, a recommendation related to a previously unselected retailer can be provided. In such embodiments, the recommendation can be based on retailers who carry the product, or carry the desired quantities and options for the product. In complementary or alternative embodiments, a retailer recommendation or suggestion can be based on similarities between other retailers, such as common customer overlap, identification in similar purchase consideration sets, similar prestige or business identity, and others. In some embodiments, consumer values (e.g., qualitative values) can be discovered by inquiry or inferred by purchasing habits and retailer preferences, and the consumer values can be applied to identify a retailer at 710.

Expanding on the above, similarities used to provide recommendations can include known or inferred values (e.g., qualitative values) and/or common consideration sets. These can be discerned at or before 710 (or after 710 in an ongoing basis for subsequent iterations of methodology 700), through automatic recognition (e.g., based on text from the store's website), by administrators or super-users (e.g., employees, delegated unaffiliated persons), or purchaser trends. In an example, a user can express a preference for a store or brand that cultivates a particular image or supports particular values. This preference can be stored and used for a variety of purposes set forth herein. In some embodiments, the user can be presented with one or more inquiries about why they preferred this store to glean further information about the user, the store, or other collateral relationships.

In other embodiments, trends can be identified based on qualitative values and/or consideration sets of multiple users. For example, stores and/or brands sharing common corporate values can be identified and grouped. Additionally, common consideration sets can be identified based on one or more preferences or values associated with a user or group of users.

Such trends can be used for predictive purposes where a user has expressed no preference toward source. For example, a user may frequently purchase clothing, but now be interested in purchasing grocery items online. If grocery items are not available from the stores where the user has been purchasing clothing, trends in their clothing purchases can be used to initially present grocery retailers in one or more consideration sets sharing their preferred clothing retailers, or groceries that are identified with values or culture similar to the preferred clothing retailers. In some embodiments, the particular products or attributes thereof carried by the grocery retailer (e.g., relative price point, brand recognition, values or identity of brands carried, geographic region) can influence whether or not the grocery retailer is presented where the user is previously agnostic to grocery retailer preference. Such aspects can facilitate rapid and accurate retailer identification and selection at 710 and 712, as well as expediting locating of products at 706.

If the check at 708 determines that the retailer does in fact carry the product located at 706, methodology 700 proceeds to complete the purchase at 714. In some embodiments, 708 can proceed to 712 if no preferences have been previously set or a retailer selection is being used in a different context (e.g., different class of products or distinct purchase).

After the retailer is identified at 710, the retailer can be selected at 712. After a retailer is selected, it can be stored in preferences such as those loaded in 704, and used in future iterations of methodology 700 (e.g., future shopping experiences or purchases).

With the product located and a corresponding retailer selected, the purchase can be completed at 714. Following completion of the purchase at 714, methodology 700 can end at 716.

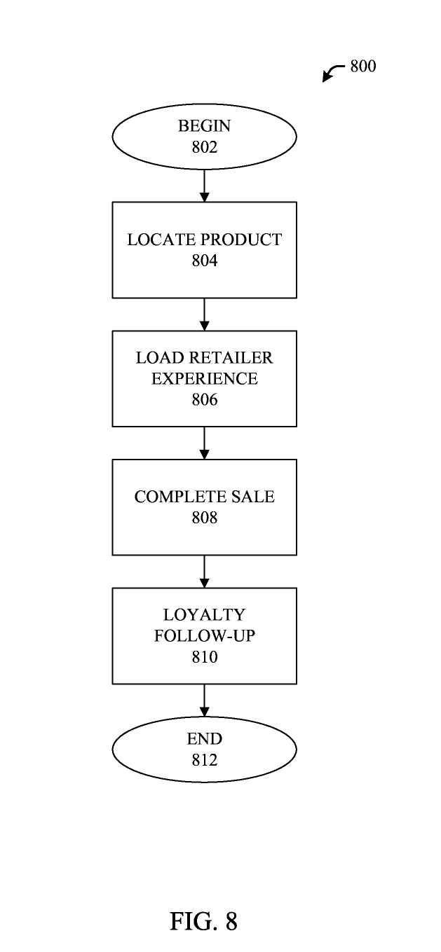

Turning now to FIG. 8, illustrated is a sample methodology 800 for loyalty-based e-commerce in accordance with one or more aspects of the disclosure herein. Methodology 800 begins at 802 and proceeds to locate a desired product at 804. At 806, a retailer experience can be loaded after a preferred retailer who carries the product is located. If no preferred retailer is available for a desired product, locating a product at 804 can include selection of a preferred retailer to be used in the current and future transactions.

A “retailer experience” can include, but is not limited to, the function and aesthetics of techniques facilitating shopping accomplished at least in part by a user on an electronic device. For example, how products are located (e.g., searching, browsing, product categories, recommendations, featured products, incentives, and others), selected (e.g., menus and interfaces to select, including options and quantities), paid for, shipped, et cetera, are all aspects of a retailer experience. Further, qualitative sensory aspects can be a part of the retailer experience. The look of a retailer's electronic shopping, such as images, fonts, sizing, styling, and so on, all sum to the retailer experience. Sound effects and music players, including the types of sounds and music, also relate to the retailer experience. Dynamic content, including aspects that change to suit one or more customers, or interact in an ongoing fashion with the customers can also be included in a retailer experience. The retailer experience can include one or more themes that can vary in the experience based on user preference, time of day, time of year, events internal or external to the retailer, and other considerations.

It is to be appreciated that, in some embodiments, the order of 804 and 806 can be reversed. If one or more preferred retailers are already established, a retailer experience can be loaded before or to be used in conjunction with locating a product. In some embodiments, the retailer experience is can be a standalone platform (e.g., installed app) that a user utilizes to shop from the retailer. In other embodiments, the retailer experience can be data loaded into a utility capable of processing more than one experience (e.g., device interface, internet utility).

Once the retailer experience is loaded, the user shops exclusively through the loaded retailer. The user can add and remove items from one or more carts and shopping lists, and complete sales including payment and shipping, but will only be presented products from the retailer associated with the retailer experience.

At 808 the sale can be completed, whereby the user confirms the products and options desired and pays for the products. Optionally, shipping can be confirmed including estimated delivery time, and other follow-up tasks (e.g., receipt generation and transmission, customer service follow-ups, and so forth.

After the sale is completed at 808, a loyalty follow-up can be performed at 810. A loyalty follow-up can include one or more aspects designed to reinforce the consumer's decision to purchase from the retailer associated with the retailer experience. Some aspects of a loyalty follow-up can include (but are not limited to, and need not include) changes to the retailer experience (e.g., features added to virtual catalog of purchases, unlock additional experience features, new music added, alternative themes), contact with the consumer (e.g., physical mailings, e-mail, social media messages, follow-up phone calls, contact via the retailer experience), incentives and offers (e.g., coupons, discounts, special offers), and others. In some embodiments, the loyalty follow-up performed at 810 can schedule action for a later date (e.g., a consumer's birthday, anniversary, holidays). Thereafter, methodology 800 ends at 812.

In some embodiments, a loyalty program including one or more loyalty follow-ups can permit a brand or retailer to identify other businesses a user can find desirable, are part of the user's consideration set, or relate to a trend associated with the user. The loyalty program can not only incentivize the user to purchase from the brand or retailer presenting the loyalty program, but provide incentives, discounts or gift cards to the other businesses. In this way, the brand or retailer can continue to develop goodwill with the user even when the user is not purchasing from said brand or retailer.

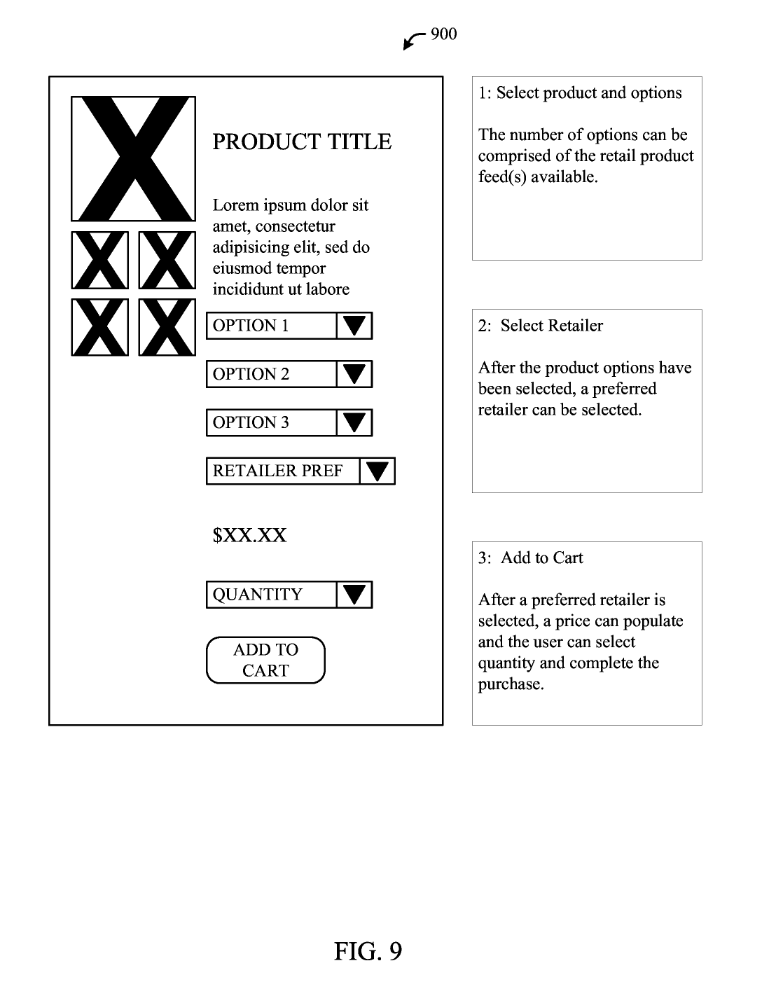

Referring now to the example experience 900 shown in FIG. 9: It is to be understood that the example shown in FIG. 9 is merely presented to provide context and perspective to the innovation and not to limit the scope of this disclosure in any manner. It is to be understood and appreciated that the example shown in FIG. 9 is the “initial” product lookup. Once a retailer is selected, the retailer preference dropdown will not be displayed or otherwise enabled. As described herein, the innovation promotes brand and retailer loyalty while minimizing (or otherwise eliminating) reliance upon price comparison shopping.

While the foregoing has generally focused toward consumer-to-business interfaces, it will be understood that various other sales structures can be accomplished using at least aspects of the subject innovation. Business-to-business sales, internal sales, and others can all leverage or adapt portions of the subject innovation to focus on relationship-driven sales as opposed to a low-price model.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. For example, it is to be appreciated that there can be instances when the service may or may not need to specifically be a Proxy service, e.g., the Standard already refers to the PCI DSS compliancy detail. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

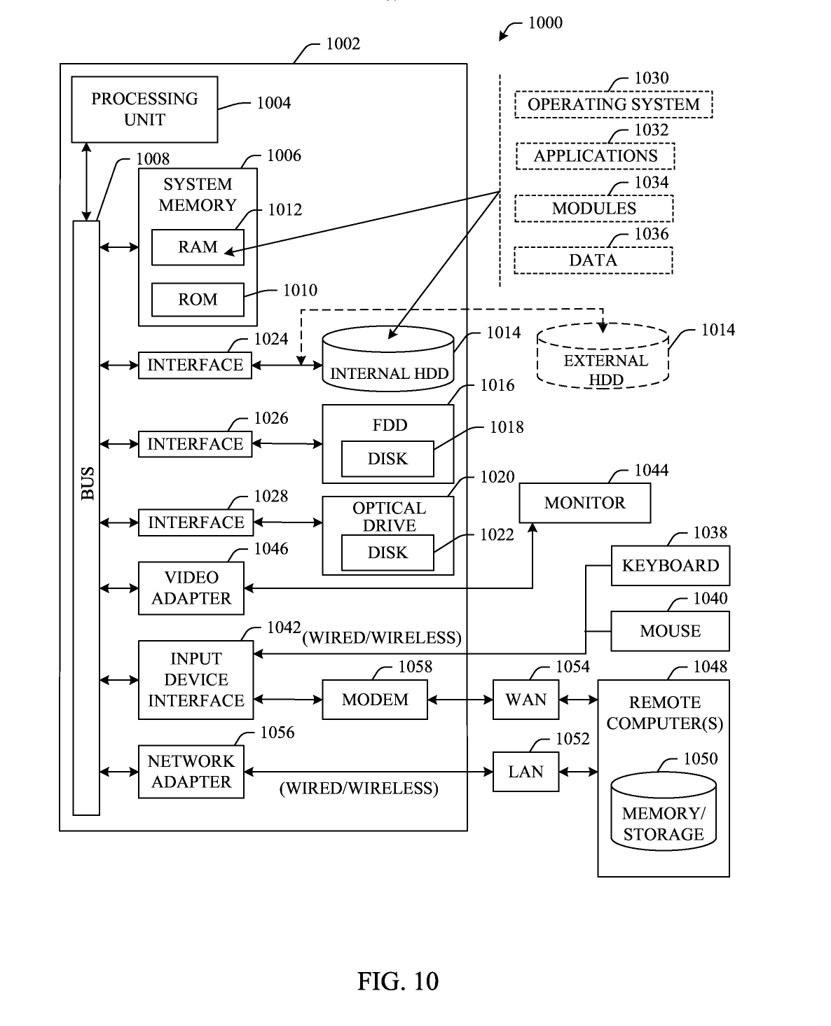

FIG. 10 illustrates a brief general description of a suitable computing environment wherein the various aspects of the subject innovation can be implemented.

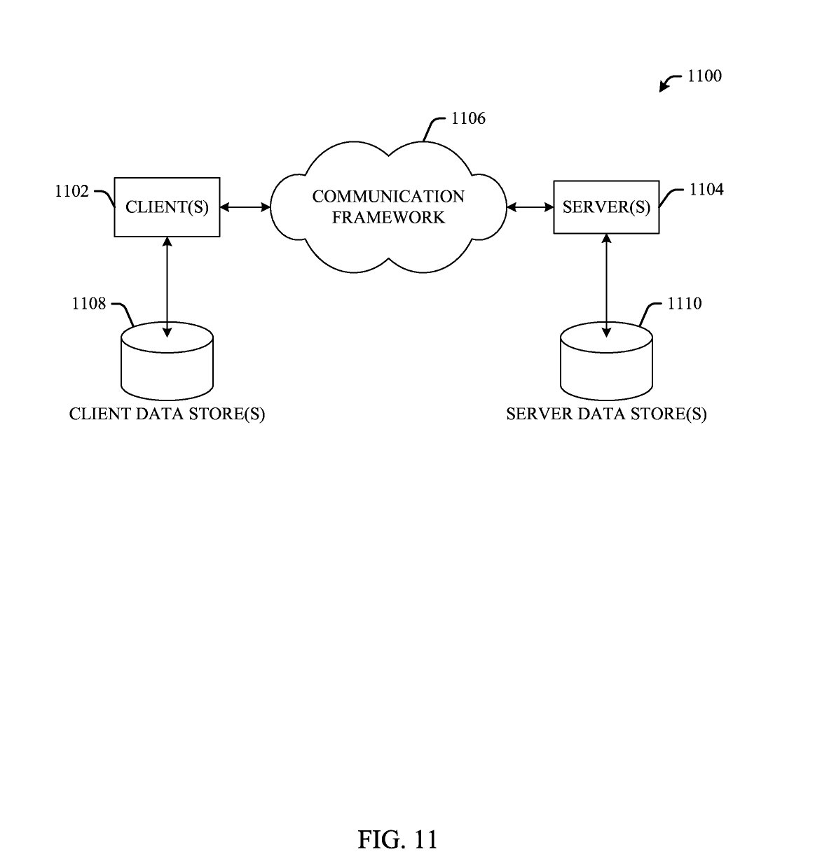

FIG. 11 illustrates a schematic diagram of a client—server-computing environment wherein the various aspects of the subject innovation can be implemented.

With reference to FIG. 10, the exemplary environment 1000 for implementing various aspects of the innovation includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA). Alternatively or in addition, an external hard disk drive 1015 may also be configured for external use in a suitable chassis (not shown), a magnetic disk drive, depicted as a floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drives 1014, 1015 magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations can include Universal Serial Bus (USB), IEEE 1394 interface technologies, and/or other external drive connection technologies.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and system memory 1006, including an operating system 1030, one or more application programs 1032, other program modules 1034 and program data 1036. All or portions of the operating system, applications, modules, and/or data can also be cached in the RAM 1012. It is appreciated that the innovation can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, et cetera.

A monitor 1044 or other type of display device is also connected to the system bus 1008 via an interface, such as a video adapter 1046. In addition to the monitor 1044, a computer typically includes other peripheral output devices (not shown), such as speakers, printers, et cetera.

The computer 1002 may operate in a networked environment using logical connections via wired and/or wireless communications to one or more remote computers, depicted as remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042 as depicted. It should be appreciated that the modem 1058 can be connected via a USB connection, a PCMCIA connection, or another connection protocol. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, et cetera) to provide secure, reliable, fast wireless connectivity. A Wi-Fi network can be used to connect computers to each other, to the Internet, and to wired networks (which use IEEE 802.3 or Ethernet).

FIG. 11 is a schematic block diagram of a sample-computing environment 1100 that can be employed for practicing aspects of the afore-mentioned methodology. The system 1100 includes one or more client(s) 1102. The client(s) 1102 can be hardware and/or software (e.g., threads, processes, computing devices). The system 1100 also includes one or more server(s) 1104. The server(s) 1104 can also be hardware and/or software (e.g., threads, processes, computing devices). The servers 1104 can house threads to perform transformations by employing the components described herein, for example. One possible communication between a client 1102 and a server 1104 may be in the form of a data packet adapted to be transmitted between two or more computer processes. The system 1100 includes a communication framework 1106 that can be employed to facilitate communications between the client(s) 1102 and the server(s) 1104. The client(s) 1102 are operatively connected to one or more client data store(s) 1108 that can be employed to store information local to the client(s) 1102. Similarly, the server(s) 1104 are operatively connected to one or more server data store(s) 1110 that can be employed to store information local to the servers 1104.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the aggregation of password rules can infer or predict support or the degree of parallelism provided by a machine based on previous interactions with the same or like machines under similar conditions. As another example, touch scoring can adapt to hacker patterns to adjust scoring to thwart successful approaches.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein (or otherwise applied) is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A system that facilitates loyalty-based commerce selection by a consumer, comprising:
a product option component that locates at least one product with desired options at one or more retailers;
a retailer selection component that selects a preferred retailer among the one or more retailers; and
a purchase component that completes a sale for the at least one product from the preferred retailer.

2. The system of claim 1, further comprising a loyalty component that commits at least the product option component and the retailer selection component to the preferred retailer.

3. The system of claim 1, further comprising a product search component that searches for a class of products including the at least one product with desired options.

4. The system of claim 1, further comprising an account component that maintains at least information related to a preferred retailer.

5. The system of claim 4, further comprising a local database component that stores at least information used by the account component.

6. The system of claim 4, further comprising a remote database query component that sends and receives at least information used by the account component.

7. The system of claim 1, wherein one or more of the product option component, the retailer selection component, and the purchase component are executed at least in part by an application on a mobile device.

8. The system of claim 1, further comprising a recommendation component that recommends a consideration set of retailers including the one or more retailers.

9. The system of claim 8, where the recommendation component bases a recommendation on a business relationship.

10. The system of claim 8, where the recommendation component bases a recommendation on a qualitative value.

11. A method, comprising:
selecting a purchase source among a plurality of purchase sources;
locating one or more products among a set of products associated with the plurality of purchase sources; and
completing a transaction involving the one or more products;
wherein selecting the purchase source filters the one or more products to a subset of products available via the purchase source.

12. The method of claim 11, further comprising populating the one or more products in a display after selecting the purchase source.

13. The method of claim 11, wherein the purchase source is a plurality of distinct vendors.

14. The method of claim 11, further comprising suggesting a purchase source for selection based at least in part on a business relationship or a qualitative value.

15. The method of claim 11, further comprising displaying pricing relating to the transaction after selecting the purchase source and locating the one or more products.

16. The method of claim 11, further comprising storing preferences including at least the purchase source.

17. The method of claim 16, further comprising applying the preferences before locating one or more subsequent products.

18. The method of claim 11, further comprising receiving a loyalty follow-up including at least one scheduled communication.

19. A system, comprising:
a data feed including at least source inventory information associated with a product source; and
a source interface that permits the product source to modify the data feed;
where a third party gains permissions to access at least a portion of the data feed by committing to complete at least a purchase for a product among the source inventory information from the source.

20. The system of claim 19, comprising:
a transformation module that converts noncompliant inventory data for integration in the data feed.
